(19) United States
(12) Patent Application Publication
(10) Pub. No.: US 2004/0000219 A1
(43) Pub. Date: Jan. 1, 2004

(54) Hexlock wrench

(76) Inventor: Christopher McNulty, Concord, MA (US)

Correspondence Address: David M. Mello, McDermott, Will & Emery, 28 State Street, Boston, MA, 02109, US

(21) Appl. No.: 10/610,055

(22) Filed: Jun. 30, 2003

Related U.S. Application Data
(60) Provisional application No. 60/392,506, filed on Jun. 28, 2002.

(51) Int. Cl. B25B 13/16

(52) U.S. Cl. 81/155

(57) ABSTRACT

A wrench comprising a handle having a fixed flat anvil surface and a pair of arms movable within the handle, said arms projecting from said handle from opposite sides of the fixed flat anvil surface and movable at an acute angle of substantially 16° 6′ with a centerline of the wrench. The arms have opposed gripping heads arranged so that their respective gripping surfaces form an abutting relationship with the entire one of the sides of the six-sided fastener when said arms are in said gripping positions. A means for moving said arms along said linear paths includes a helical thumbscrew disposed between the arms and configured to engage threaded portions of the arms.

### CROSS REFERENCES TO RELATED APPLICATIONS

This application claims the benefit of priority under 35 U.S.C. §119(e) from co-pending, commonly owned U.S. provisional patent application serial No. 60/392,506, entitled HEXLOCK WRENCH, filed Jun. 28, 2002.

### STATEMENT OF GOVERNMENT INTEREST

The U.S. Government has no interest in or to the present invention.

### FIELD OF THE INVENTION

The invention relates generally to gripping tools and more particularly to an adjustable wrench suitable for use on six-sided fasteners.

### BACKGROUND

Six-sided or “hex-head” fasteners such as screw heads and nuts are in wide use. Many hand-held devices have been developed over the years for use on six-sided fasteners. Principal among these wrenches are the adjustable wrenches which allow the user to utilize the same wrench for different size fasteners. Of the open end adjustable wrenches used on hex-head fasteners, the so-called “crescent” wrench is the best known. The crescent wrench has an open end between a fixed gripping head and another gripping head which is adjustable by a rotatable screw. One disadvantage of the crescent wrench when used on hex-head fasteners is that the gripping heads only bit two of the six sides. Another disadvantage is that the adjusting screw is oriented transversely to the longitudinal axis of the wrench handle, thereby causing the crescent wrench to have a large width adjacent to the gripping heads which may not conveniently fit a fastener because of obstructions located adjacent to the hex-head.

A number of problems are common to any wrench which only grips two sides of a polygonal fastener. Among these is a relatively “poor grip” which causes the wrench to slip which in turn causes rounding of the corners of the fastener. This problem is particularly troublesome where it is necessary to loosen a very tight or “frozen” fastener.

U.S. Pat. No. 183,266 to Jordan, U.S. Pat. No. 1,242,097 to Anderson and U.S. Pat. No. 3,358,533 to Wren disclose other mechanical arrangements in which two jaws close in on the fastener in order to grip it. Such arrangements eliminate some problems associated with the standard crescent wrench, but the fastener is still only gripped on two of its six sides. As a result, torque is being exerted on the fastener only at two opposite sides of the six-sided fastener. In Jordan and Wren, two additional sides of the fastener may come in contact with the wrench, however, if such contact is made there is only minimal force exerted by the wrench upon those two sides, and in any event that force is not equal to the force exerted on the fastener by the two jaws. Any such additional unequal force exerted on the fastener will not provide markedly improved grip nor will it alleviate the problem of rounding edges.

U.S. Pat. No. 3,670,604 to Fronell discloses a wrench which grips the hex-head fastener on three sides. Fronell, however, does not disclose an open end wrench but rather discloses a spanner which must completely surround the fastener. In U.S. Pat. No. 433,358 to McCarthy, a wrench is disclosed that utilizes two extending arms with gripping heads. McCarthy, however, is only concerned with improvements in the strength and adjusting mechanism of a wrench and not with any special gripping configuration which makes the wrench more useful on six-sided fasteners.

U.S. Pat. No. 4,534,246 discloses an improvement over the foregoing by providing a “hexlock wrench” employing typical cylindrical thumbscrew means for moving the arms (and heads) of hexlock wrench. While this approach is an improvement, the mechanism for moving the gripping means of the wrench is relatively complicated and, depending on the placement of the traditional thumbscrew can be awkward to manipulate when holding the wrench.

### SUMMARY OF THE INVENTION

A hexlock wrench in accordance with this invention includes two gripping heads each formed on one of two arms that protrude symmetrically from one end of the handle. Each gripping head has a gripping surface, and each gripping surface grips one of the sides of a six-sided fastener. On the top of the handle between the two arms there is a fixed, flat anvil surface which grips a third side of the six-sided fastener. A hexlock wrench in the gripping position will grip the six-sided fastener on each alternate side.

In one embodiment, the arms are mounted in the handle in such a way that they will slide in and out of the handle so as to accommodate different size fasteners. For any size fastener within the predetermined range, all three gripping surfaces will be in a flat, abutting, gripping relationship with three alternate sides of the fastener. The path along which the arms slide forms an angle of about 16° 6′ with a central longitudinal axis of the handle which bisects the fixed flat anvil surface. These arms then form an angle of about 133° 54′ with the gripping surfaces of the gripping heads. By utilizing such dimensions, the hexlock wrench will always exert equiangular force upon the fastener and the upper end of the jaws always make contact with the outer corners of the six-sided fastener.

The arms may each include a threaded portion as part of a means for adjusting and controlling the translation of the arms. Disposed between the threaded portions of the arms is a tapered thumbscrew that is threaded to simultaneously mate therewith. The thumbscrew may include a variable helix thread pattern.

The handle portion of such a hexlock wrench may be made as a two piece handle using known broaching techniques or using precision casting techniques, or some combination thereof. In other forms the wrench may be made using metal injection molding (MIM) techniques, in which case the handle may take the form of a one piece handle.

### BRIEF DESCRIPTION OF THE DRAWINGS

The drawing figures depict preferred embodiments by way of example, not by way of limitations. In the figures, like reference numerals refer to the same or similar elements.

FIG. 1A is a side view of a hexlock wrench in accordance with the present invention, the hexlock wrench engaging a small sized fastener. And, FIG. 1B illustrates the forces applied to the fastener by the hexlock wrench of FIG. 1A.

FIG. 2 is a perspective view of the hexlock wrench of FIG. 1A engaging a medium sized fastener.

FIG. 3A, FIG. 3B and FIG. 3C are views showing the interior portion of the hexlock wrench of FIG. 1A.

FIG. 4A and FIG. 4B are diagrams showing the tapered helical thumbscrew of the hexlock wrench of FIG. 1A.

### DETAILED DESCRIPTION OF THE PREFERRED EMBODIMENTS

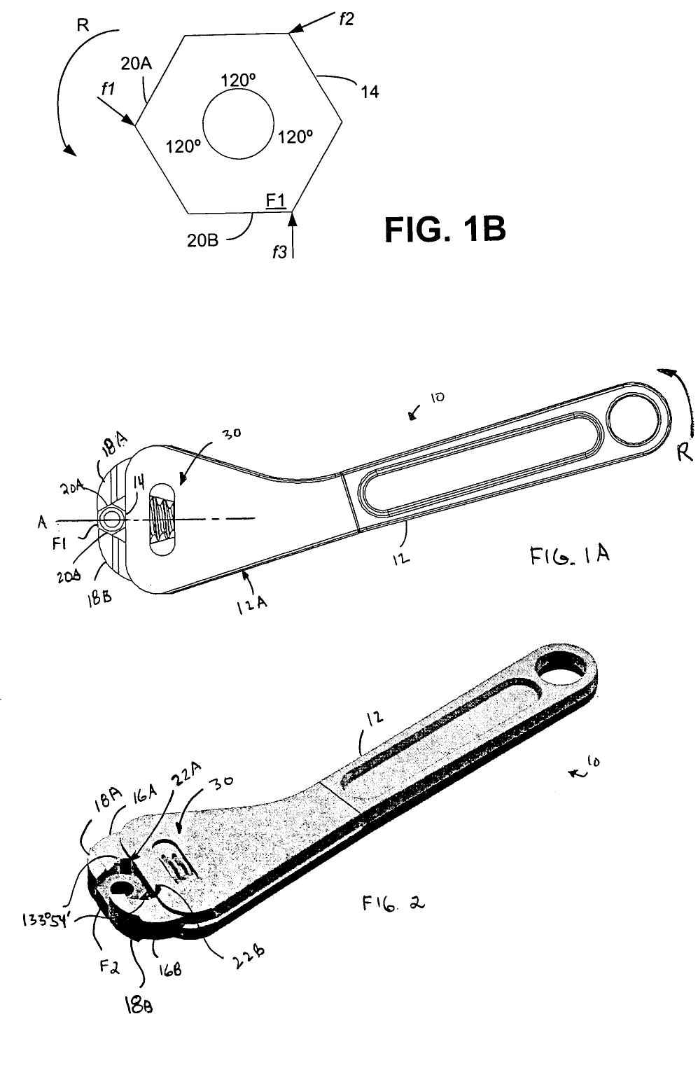

Referring to FIGS. 1A-3C, an embodiment of an adjustable open end hexlock wrench 10 for use on six-sided or hexagonal-shaped fasteners is variously shown. These six-sided shaped fasteners have six sides of equal length. Every fastener side forms a 120° angle with each of its two adjacent sides. The hexlock wrench 10 includes 3 surfaces configured to grip every other side of the fastener, which results in substantially equal forces being applied to the gripped sides of the fastener, as is shown in FIG. 1B (discussed in more detail below).

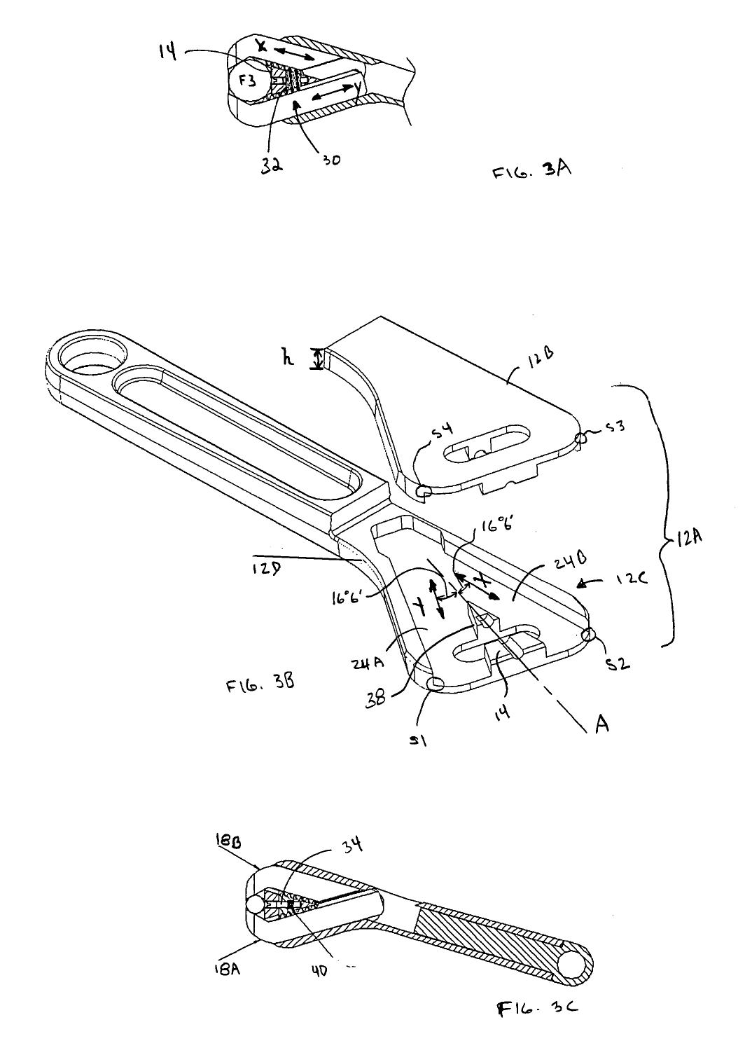

In FIG. 1A, an adjustable hexlock wrench 10 according to the present invention has a longitudinally extending handle 12. On one end of the handle 12 there is a fixed, flat anvil surface 14, against which one side of the six-sided fastener F1 is placed, here fastener F1 is a relatively small sized fastener. Projecting from the same end of the handle 12 as the anvil surface 14 are two arms 16A, 16B, movable along linear paths by an adjustment means 30. The arms 16A, 16B and adjustment means 30 are movably disposed within a handle head 12A. Secured on the end of each arm 16A, 16B there is a gripping head 18A, 18B, respectively. Preferably these gripping heads 18A, 18B and their respective arms 16A, 16B are integrally formed out of a high strength hard material, such as forged steel. Each of these gripping heads 18A, 18B is configured to “grip” a side of the six-sided fastener F1 by forming a generally flat, abutting relationship between an associated gripping surface 20A, 20B and the corresponding side of fastener F1. In the preferred form, the gripping heads 18A, 18B are formed on the arms 16A, 16B in such a way that the gripping surface 20A of gripping head 18A and the gripping surface 20B of gripping head 18B form an angle of about 133° 54′ with an arm surface 22A and 22B, respectively, that face the central longitudinal axis A, see FIG. 2.

The arms 16A, 16B are mounted within the handle 12 in such a way so as to allow for sliding movement into and out of the handle 12, without compromising the abutting relationships of the gripping surfaces 18A, 18B and anvil 14 with whatever sized fastener that may be gripped, and the equal forces that are applied to every other side of the fastener. The arms 16A, 16B slide between a gripping position and a releasing position. Preferably, the arms 16A, 16B slide along a linear path that forms an angle of about 16° 6′ with the central longitudinal axis A of handle 12, see FIG. 3B. The central longitudinal axis A bisects the fixed flat anvil surface 14. The angle formed by the linear paths and the central longitudinal axis A remain the same regardless of the size of the fastener the wrench is gripping, i.e., and the extension of arms 16A, 16B. The surfaces 22A, 22B are parallel to their associated linear paths. Stated more generally, the gripping surface 20A, 20B of each head 18A, 18B forms an angle of about 133° 54′ with the linear path of motion of the associated arm 16A, 16B.

In use, the ability to extend the arms 16A, 16B allows the wrench to accommodate any size fastener within a predetermined dimensional range. For example, FIG. 2 shows the hexlock wrench 10 of FIG. 1A gripping a medium sized fastener F2. The precise angular dimensions of the mounting of the gripping heads on the arms and of the paths along which the arms slide assure that there will always be a perfect “bite” on three alternate sides of the six-sided fastener. This perfect bite results in an equiangular application of three gripping forces upon the fastener, as is shown by force vectors f1, f2, and f3 in FIG. 1B. Also, each gripping surface of the wrench, the anvil surface 14, and the flat gripping surfaces 20, 20 of the heads 18, 18 will each be in a face-abutting relationship with one side of the fastener.

FIG. 3A through FIG. 3C show a cross section of an upper portion, including a handle head 12A, of wrench 10 of FIG. 1A. In FIG. 3A wrench 10 is shown gripping a large sized fastener F3. In this embodiment, arms 16A and 16B each travels in its own linear path in response to actuation of adjustment means 30. As is shown in FIG. 3A, arm 16A travels in a path defined by double arrow Y and arm 16B travels in a path defined by double arrow X. To ensure travel along these paths, channels are formed within the handle head 12A, for example channel 24A for arm 16A and 24B for arm 16B (see FIG. 3B). Here, handle head 12A includes a cover 12B and a body portion 12C formed within handle 12. When assembled, cover 12B and body portion 12C encase the arms 16A, 16B and adjustment means 30. In FIG. 3A and 3C cover 12B is not shown.

In the embodiment of FIG. 3A through 3C, handle 12 may be formed by precision casting, requiring no second machining. Traditional broaching methods are not preferred, since they would require boring channels throughout the length of handle 12. Those holes would then need to be broached the full length of handle and plugging the end of the channel with a handle extension, rather than just covering handle head 12A with cover 12B. Therefore, the broaching approach would require more complex handle parts and longer machined channels, which would be far less desirable in terms of manufacturing costs and overall durability and strength of wrench 10. In this embodiment, cover 12B need not be formed any longer then required to encase arms 16A, 16B.

Tests have shown that the highest areas of stress experienced by handle head 12A during typical use of wrench 10 occur at high stress areas S1-S4, shown in FIG. 3B. Accordingly, handle 12 is preferably formed to avoid seams at the high stress areas, since these would be vulnerable to cracking. Therefore, the height h of cover 12B is chosen such that the seam formed with handle body portion 12C is proximate to a midline 12D of handle head 12A. Handle cover 12B can be made from forged steel and welded to body portion 12C at the midline 12D. Other processes of coupling cover 12B to body portion 12C can be used, but it is preferred that such couplings avoid seams at the high stress areas S1-S4. In embodiments where broaching is used to form channels 24A and 24B, similarly, seams should avoid high stress areas S1-S4.

Another process for making a hexlock wrench in accordance with the present invention is metal injection molding (MIM). Using MIM, handle 12 can be formed as a single unit having channels 24A, 24B formed therein and accommodating encasement of the adjustment means, without the need for a separate cover, e.g., cover 12B. In such a case arms 16A, 16B would be slid into channels 24A, 24B, then a thumbscrew 32 (discussed below) could be inserted though the side of the handle head 12A to engages threaded portions 26A, 26B of arms 16A, 16B, and then a thumbscrew shaft 34 could be installed via an opening in anvil 14 to maintain the thumbscrew 32, which in turn maintain the arms 16A, 16B within handle 12.

Regardless of the process for making the handle 12 of hexlock wrench 10, the adjustment means 30 preferably includes a helical thumbscrew 32. Accordingly, as is shown in FIG. 3A, arm 16A includes threaded portion (or teeth) 26A and arm 16B includes threaded portion 26B. Helical thumbscrew 32 is disposed within handle head 12A such that it simultaneously and operatively engages the threaded portion 26A of arm 16A and the threaded portion 26B of arm 16B.

In this embodiment, helical thumbscrew 32 includes or is positioned on thumbscrew shaft 34, about which the thumbscrew is rotatable. Thumbscrew shaft 34 is disposed along central longitudinal axis A. A shaft first end 34A is coupled to anvil 14 and an opposite, second end 34B is coupled to shaft pocket 38 formed within handle head 12A, as is shown in FIG. 3B. As can be seen from FIG. 3C, a spring 40 is also included on thumbscrew shaft 34, and provides a manner of loading the helical thumbscrew 32, thereby preventing undesirable rotation of thumbscrew 32. Thumbscrew 32 and shaft 34 act to allow rotation of the thumbscrew 32 relative to the handle 12 and about the central longitudinal axis A. Rotation of thumbscrew 32 causes linear displacement of each of arms 16A, 16B with in their respective channels 24A, 24B. The linear displacement of the arms 16A, 16B allows for engaging and disengaging grip heads 18A, 18B, while also maintaining the 16° 6′ angles of arms with respect to the central longitudinal axis A and the 133° 54′ angles of the grip heads 18A, 18B with respect to the arms 16A, 16B.

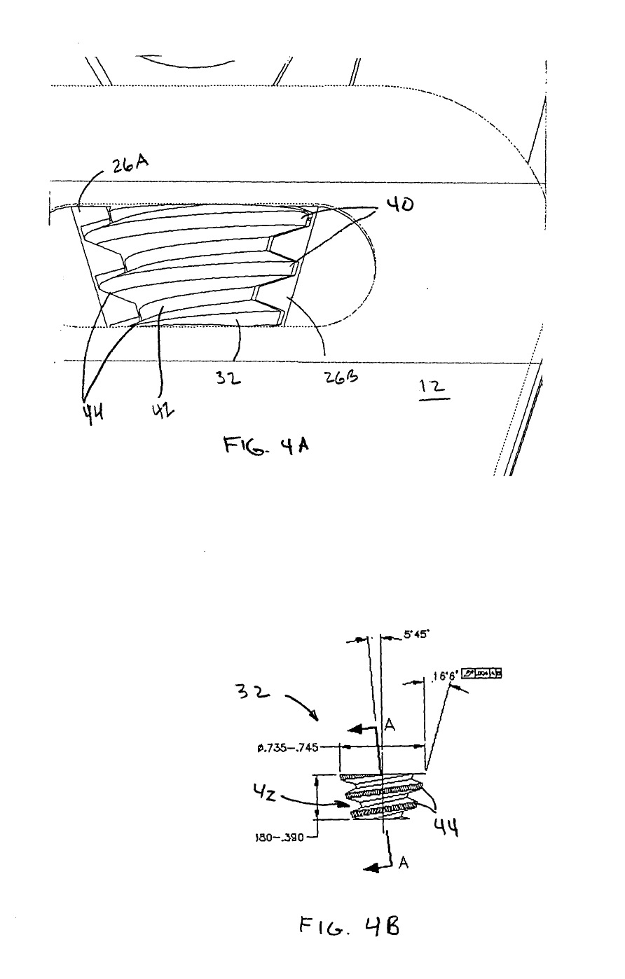

In the preferred form, the threaded portions 26A, 26B of arms 16A, 16B are threaded at 6 threads per inch, with uniform spacing between the threads. Theoretically, it follows that to properly mate with the threaded portions 26A, 26B, the helical thumbscrew 32 should also be threaded at about 6 threads per inch, measured perpendicular to the tapered surface 42 of the thumbscrew 32, see FIGS. 4A and 4B. In order for the tapered thumbscrew to mate properly with the threaded portions 26A and 26B, the helix angle of the thumbscrew will vary around an average value (e.g., 5° 45′). However, rather than 6 threads per inch (or 1 thread every 0.1666667 inches), experimentation showed that iterating the pitch on the thumbscrew 32 from 1 thread every 0.1666667 inches (i.e., 6 threads per inch) to about 1 thread every 0.160 inches results in a better match with the teeth of threaded portions 26A, 26B of arms 16A, 16B.

FIG. 4A shows a portion of thumbscrew 32 and FIG. 4B shows thumbscrew 32 within handle 12 and engaged with arm threaded portions 26A, 26B. The thumbscrew threads 44 are formed at constant speed with a cut angle of substantially equal to an average helix angle, the average helix angle chosen to be about 5° 45′ in this embodiment to accommodate the angles of threaded portions 26A, 26B of arms 16A, 16B. Using the 5° 45′ cut angle, rather than a straight cut angle, and using a constant cut speed causes the tapered thumbscrew to have a helical thread with a variable thread angle. By variable helical thread angle it is meant that the angle of the teeth 44 of the thread of thumbscrew 32 with respect to the central longitudinal axis A gets larger as the thread works toward the smaller diameter end of the taper. As a result, the angle of 16° 6′ of the arms is preserved, as is the angle of about 133° 54′ of the head grips 18A, 18B. Consequently, the grip heads 18A, 18B and anvil 14 apply substantially equal forces against 3 different sides (120° apart) of a fastener being rotating in direction of arrow R, as shown in FIG. 1B.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. As used herein, the terms “includes” and “including” mean without limitation. It is intended by the following claims to claim any and all modifications and variations that fall within the true scope of the inventive concepts.

What is claimed is:

1. A wrench comprising:
A. a handle having a fixed flat anvil surface centered on one end of said handle, said fixed flat anvil surface being in an abutting relationship with an entire one side of the fastener when said fastener is gripped;
B. a pair of arms mounted in said handle for sliding movement along associated linear paths between a gripping position and a release position, said arms projecting from said handle from opposite sides of said fixed flat anvil surface and said linear paths each forming an acute angle of substantially 16° 6′ with respect to a centerline of the wrench;
C. a pair of opposed gripping heads, one formed on the end of each of said arms with each of said gripping heads having a gripping surface, said gripping heads arranged so that each of said gripping surfaces is in an abutting relationship with the entire one of the sides of the six-sided fastener when said arms are in said gripping positions, said gripping surfaces and said fixed flat anvil surface being arranged to apply substantially equiangular gripping force to three alternate sides of said six-sided fastener; and
D. means for moving said arms along said linear paths between said gripping and releasing positions, said means including a helical thumbscrew disposed between the arms and configured to engage threaded portions of the arms.

2. The wrench of claim 1, wherein said gripping heads are integrally formed on said arms.

3. The wrench of claim 1, wherein said gripping heads are integrally formed on said arms such that said gripping surfaces of said gripping heads form an angle of substantially 133° 54′ with said linear path of the associated arm.

4. The wrench of claim 3 wherein said gripping surfaces form an included angle of about 60° to one another.

5. The wrench of claim 1 wherein said gripping forces are equiangularly spaced from each other.

6. The wrench of claim 5 wherein said equiangular relationship is maintained regardless of the location of said gripping heads along said linear paths.

7. The wrench of claim 1, wherein the helical thumbscrew has about 6 threads per inch.

8. The wrench of claim 1, wherein the helical thumbscrew has about 1 thread every 0.160 inches.

9. The wrench of claim 1, wherein the helical thumbscrew has a 16° 6′ taper with respect to the centerline.

10. The wrench of claim 1, wherein the handle is a one piece handle, within which the helical thumbscrew and arms are movably housed.

11. The wrench of claim 1, wherein the thumbscrew has a thread angle of about 5° 45′.

12. The wrench of claim 1, wherein the thumbscrew has a thread angle cut along an average helix angle.

13. The wrench of claim 1, wherein the handle is formed from metal injection molding.

14. The wrench of claim 1, wherein the handle is formed from precision casting.

15. A wrench comprising:
A. a handle having an anvil grip surface;
B. a first arm adjacent to the anvil grip surface and having a first grip movable in a linear direction at an angle of about 16° 6′ with respect to a centerline that is perpendicular to the anvil grip surface;
C. a second arm adjacent to the anvil grip surface and opposite to the first arm, the second arm having a second grip movable in a linear direction at an angle of about 16° 6′ with respect to the centerline, wherein the anvil grip surface, the first grip and the second grip are disposed to apply substantially equal forces on alternate sides of a 6-sided fastener gripped therebetween; and
D. a helical thumbscrew tapered at an angle of about 16° 6′ with respect to the centerline and operatively disposed between a set of first teeth of the first arm and a set of second teeth of the second arm, the thumbscrew configured to effect coincidental movement of the first grip and the second grip, while substantially maintaining the angular relationship of the first grip and second grip with respect to the centerline.

16. A method of making a hexlock wrench, comprising:
A. forming a single piece handle using metal injection molding, including within the handle:
1) forming an anvil grip surface;
2) forming adjacent to the anvil grip surface a first channel and an opposite second channel at angles of about 16° 6′ with respect to a centerline perpendicular to the anvil grip surface;
3) forming adjacent to the anvil grip surface a helical thumbscrew opening within the handle, along the centerline and between the first channel and second channel;
4) forming, along the centerline, a top thumbscrew shaft pocket above the helical thumbscrew opening and a bottom thumbscrew shaft pocket below the helical thumbscrew opening;
B. disposing within the first channel a movable first arm having a first grip;
C. disposing within the second channel a movable second arm having a second grip, wherein the anvil grip surface, the first grip and the second grip are disposed to apply substantially equal forces on alternate sides of a 6-sided fastener gripped therebetween;
D. disposing within the thumbscrew opening a helical thumbscrew tapered at an angle of about 16° 6′ with respect to the centerline, including engaging a set of first teeth of the first arm and a set of second teeth of the second arm; and
E. installing a thumbscrew shaft axially within the thumbscrew, including installing a shaft top end in the top thumbscrew shaft pocket and a shaft bottom end in the bottom thumbscrew shaft pocket.

17. The method of claim 16, including cutting teeth of the thumbscrew at a constant speed.

18. The method of claim 16, including cutting teeth of the thumbscrew such that the helix angle of the teeth with respect to the thumbscrew shaft increases moving down the taper.

19. The method of claim 16, including cutting the thumbscrew at an average helix angle

20. The method of claim 19, wherein the average helix angle is about 5° 45′.
